(19) United States
(12) Patent Application Publication
(10) Pub. No.: US 2009/0076934 A1
(43) Pub. Date: Mar. 19, 2009

(54) PERSONALIZED CUSTOMER TRANSACTION SYSTEM

(76) Inventors: Hamed Shahbazi, Vancouver (CA); Laurent May, North Vancouver (CA)

Correspondence Address: HENSLEY KIM & HOLZER, LLC, 1660 LINCOLN STREET, SUITE 3000, DENVER, CO, 80264, US

(21) Appl. No.: 12/234,551

(22) Filed: Sep. 19, 2008

Related U.S. Application Data
(60) Provisional application No. 60/973,697, filed on Sep. 19, 2007.

(51) Int. Cl. G06Q 20/00; G06Q 10/00; G06Q 40/00

(52) U.S. Cl. 705/30; 705/35; 705/40; 705/44; 705/43

(57) ABSTRACT

A variety of products and services can be integrated and personalized by a self-service kiosk. A self-service terminal that originates a financial transaction, the self-service terminal may comprise a physical payment interface integrated with the self-service terminal, a personalized interaction management module that accesses a user account, the user account identifying payment obligations of a user to a plurality of payees, an input adapter that detects selection of an identified payment obligation to a payee, a transaction management module that receives an originating instruction via the self-service terminal to originate payment associated with the selected payment obligation, funds designated for the payment being specified via the physical payment interface, and a transaction processing module that transmits a payment instruction specifying the payment for application against the selected payment obligation.

### CROSS-REFERENCE TO RELATED APPLICATIONS

This application claims benefit of United States Provisional Application No. 60/973,697, entitled “Personalized Customer Transaction System” and filed on Sep. 19, 2007, which is specifically incorporated herein by reference for all that it discloses and teaches.

### TECHNICAL FIELD

The invention relates generally to computer systems, and more particularly to personalized customer transactions for electronic kiosks.

### BACKGROUND

To date, self-service terminals such as kiosks have primarily been used to provide a specially-targeted product or service. For example, a movie ticket kiosk can sell movie tickets at a theater. Likewise, an Internet kiosk can provide pay-as-you-go Internet access at airports and malls. Furthermore, purchases through kiosks are often single instance purchases, impersonal and lack customer friendly functionality.

However, there exist large segments of the population that neither have bank accounts nor internet access. These people have been left with few payment options for common household bills such as phone, electricity, cable, etc. Furthermore, the currently available options do not allow users access to features and services available to those with bank accounts or internet access. Existing kiosks and bill payment systems fail to provide an adequate solution to these problems.

### SUMMARY

Implementations described and claimed herein address the foregoing problems by allowing a user to establish a user account for a personalized experience and increased functionality in a self-service terminal such as a kiosk. This user account provides benefits such as continuity from transaction to transaction and from billing account to billing account with a single user interaction. Using a personalized user account, a user may log in to a kiosk using uniquely identifying user information (e.g. user identifier and password). The user may then either access an existing account on the kiosk or create a new account. If a user is new, the kiosk may provide the user with step by step instructions about setting up a new personalized user account. These steps may include prompting a user for personal information and billing account information. The kiosk may then use the provided billing account information to retrieve billing information associated with the users billing accounts. The kiosk may also store the billing account information along with other user inputs in a manner that can allow the user to retrieve information at a later point in time.

Once a user has created an account, the kiosk may display all or a selected few of the bills associated with the user's account. The kiosk provides the user with additional functionalities such as the ability to manipulate the displayed bill data and modify the user account settings. The personalized user account also allows a user to pay multiple bills from different billing accounts associated with the user account with funds received through a physical payment interface associated with the kiosk. Once a kiosk has received funds, the kiosk may communicate to the user that the funds have been applied to the selected bill and the user account may be updated to incorporate the payment.

A personalized user account on a kiosk is a way of capturing and making more tangible the currently transitional and ephemeral interaction between the customer and the terminal. The personalized user account also represents an attempt to retain users by adding value through more useful and integrated functionality and information.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program.

Other implementations are also described and recited herein.

### BRIEF DESCRIPTION OF THE DRAWINGS

FIG. 1 illustrates an exemplary self-service terminal with a network connection to a variety of service computers.

FIG. 2 illustrates an exemplary screenshot from a user interface of a self-service terminal.

FIG. 3 schematically illustrates a personalized payment obligation service.

FIG. 4 schematically illustrates an exemplary a self-service terminal.

FIG. 5 illustrates exemplary operations for processing a personalized transaction with a self-service terminal.

FIG. 6 illustrates exemplary operations for creating a personalized user account and processing a personalized transaction with a self-service terminal.

FIG. 7 illustrates an exemplary computing system that may be useful in implementing the described technology.

### DETAILED DESCRIPTIONS

Self service terminals such as kiosks can provide a platform for a variety of vending services, communication services, and financial services. For example, a conveniently located kiosk (e.g., in a mall or convenience store) can accept customer payments for household bills, vend tickets for sporting events, and sell minutes for a prepaid phone card. Integration of a variety of services into a convenient, personalized kiosk provides a “one-stop-shop” for consumers to quickly and easily complete a number of diverse and otherwise inconvenient tasks. Additionally, a kiosk is further enhanced by linking individual transactions together, storing user information in a user account and allowing a user to dispense funds to multiple payees.

A kiosk provides a user a personalized interaction through a user account, while allowing the user to act in a fully “self-service” manner. A user may, among other activities: create an account, log into an existing account, management and modify user settings for an account, manage and modify billing account settings for an account, provides funds to pay a bill, view payment histories, purchase goods or services, etc. all without have to interact with any teller or service personnel. For the purposes of the below described invention a self-service terminal may include an electronic kiosk, a kiosk, etc. Furthermore, billers may be described as payees, obligees, etc.

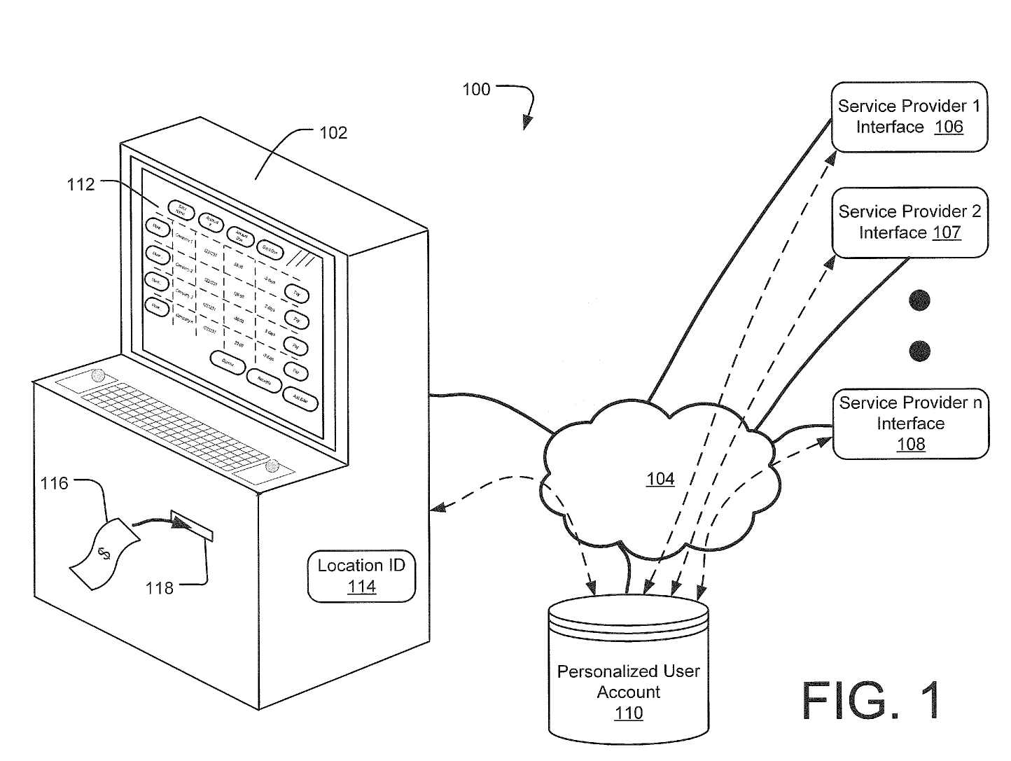

FIG. 1 illustrates an exemplary self-service terminal 100 with a network connection 104 to an exemplary personalized payment obligation database 110. An electronic kiosk 102 is shown having a display, a keyboard input, and trackball inputs. Alternate implementations can vary the structure and hardware components that make up an electronic kiosk. For example, in one implementation, a touch-screen is employed as an input device. In another implementation, a mouse is used as an input device. In yet another implementation, a trackball functions as an input device.

The electronic kiosk 102 in FIG. 1 has a funds receiving physical payment interface 118. Funds 116 are identified or received into the physical payment interface 118. By way of example and not limitation, funds may be indentified by scanning and validating currency, checks, credit cards, money orders, etc. Currency, checks, and money orders may be received into the electronic kiosk 102 and stored in a secured location within the electronic kiosk 102, such as an internal or attached vault. Validation can determine the validity of the instrument (e.g., the cash, the check, etc.) and may also determine the amount of funds 116 designated for payment and the identity of the payor. Although not shown in FIG. 1, it should be appreciated that the electronic kiosk 102 can accept multiple sources of inputs and can output many different items as well. For example, the kiosk funds receiving physical payment interface 118 may include a money order receiving device, a check receiving device, a credit card receiving device, etc. Furthermore, the kiosk 102 may print receipts, output tickets to sporting events, print coupons, output lottery tickets, charge prepaid cards, etc.

The electronic kiosk 102 is connected to a personalized payment obligation database 110 through a network 104. In one implementation, the network 104 is the Internet. In another implementation, the network 104 is a Wide-Area-Network or WAN. In yet another implementation, each electronic kiosk 102 has a dedicated, secure connection to a network 104 that links the kiosk 102 to one or more service provider interfaces 106-108 through the personalized user account database 110.

The service provider interfaces 106-108 provide access to transaction processing for the services and products offered by the electronic kiosk 102. In operation, service provider interfaces 106-108 may allow the personalized user account database 110 to interface through a web service that is hosted on a transaction server which interfaces with a service provider database. By way of example and not limitation, service provider interface 106 may be associated with the local electric utility company, and service provider interfaces 107 may be owned by a cellular phone company. Kiosk 102 may transmit a communication to the personalized user account database 110 via the network 104.

The personalized user account database 110 may communicate with service provider interfaces 106 and 107 to authenticate the user account information associated with the electricity bill and cellular phone bill for this particular user. The personalized user account database 110 may also gather transaction process information from the service provider interfaces 106 and 107 in order to structure and complete the transaction process. Furthermore, the personalized user account database 110 may gather; transaction histories, payment due dates, etc. from the service provider interfaces 106-108. Different servers or combinations of servers can provide the communications, computations, and data required to execute a transaction through the kiosk.

By way of example and not limitation, a user can interact with the electronic kiosk 102 through a user account to complete a variety of tasks. A user accesses the kiosk 102 at a publically accessible place of business for the purpose of paying multiple payment obligations due to multiple payees. If the user has a user account already set up, the kiosk 102 prompts the user to input the required uniquely identifying user information to allow the user access to his or her user account. This uniquely identifying user information may include a username, password, user phone number, fingerprint scan, voice authentication, etc. If a user does not have a pre-existing user account, the kiosk 102 can prompt the user to input user and billing account data to allow the kiosk 102 to create a new account and associate billing account data with the new user account.

Once a user has access to billing account information associated with his or her account, the user selects from a number of options, such as but not limited to, paying a bill, highlighting a bill for future considerations, adding a new billing account, subtracting an existing billing account, modifying user access parameters, viewing bill paying transaction histories, viewing transaction location histories, etc. If a user selects to pay a bill the kiosk 102 prompts the user to provide funds to pay the bill through a physical payment interface.

The kiosk 102 may accept funds in a number of forms, such as but not limited to, currency, checks, credit cards, money orders, pre-paid cards, coupons, etc. In the case of accpeting cash, the kiosk 102 accepts cash through a physical payment interface and applies the cash amount towards the selected bill by transmitting payment designated for the selected bill. The kiosk '02 can also provide a user with options for what to do with any funds remaining after the selected bill payment has been transmitted. The user can select to make a payment towards another billing account, or select from a variety of goods and services provided by the kiosk, such as gift cards, coupons, module phone minutes, etc.

Once the kiosk 102 has accepted funds, originating instructions are sent from the kiosk 102 to a personalized user account database 110. In an implementation, the originating instructions are associated with a location identifier designated to the kiosk 102. The location identifier can include information pertaining to the physical location of the kiosk 102 such as Global positioning System (GPS) data, latitude and longitude data, location name, store name, address, zip code, etc. Alternatively or in addition, the location identifier can identify an individual kiosk 102, such as by representing a service or transaction generated terminal identifier, a kiosk generated kiosk identifier, a Globally Unique Identifier (GUID) associated with the kiosk 102, etc.

Location identifiers are useful to track transactions by location; to identify kiosk functions used at individual kiosk locations; to track payees being serviced through individual kiosks, to monitor currency, checks, etc. being stored in vaults based on each transaction. In this manner, the payment obligation database can assist in back-end management of the kiosk and provide marketing analytics for indiviudal kiosks. For example, the location identifier can allow the payment obligation database to identify a kiosk location is used frequently for payment to a particular payee. Such information may be useful to the payee or the payee's competitors in determining where to advertise or provide other promotional activities.

It should be understood that each instruction processed or transmitted by the kiosk may include one message or a series of messages to effect the desired processing activity. For example, an instruction may include a first message identifying the user information and a subsequent message identifying the payee information. Many types of instructions may be employed in other implementations.

The personalized user account database then transmits instructions to selected service provider interfaces 106-108 instructing the service provide interfaces 106-108 to apply the received funds toward the users billing account. The service provider interfaces 106-108 apply the funds to the users billing account and transmit a confirmation of application of the funds. In these cases, the personalized user account database may store the confirmation with the user account and transmit the confirmation information to the kiosk for the user's benefit.

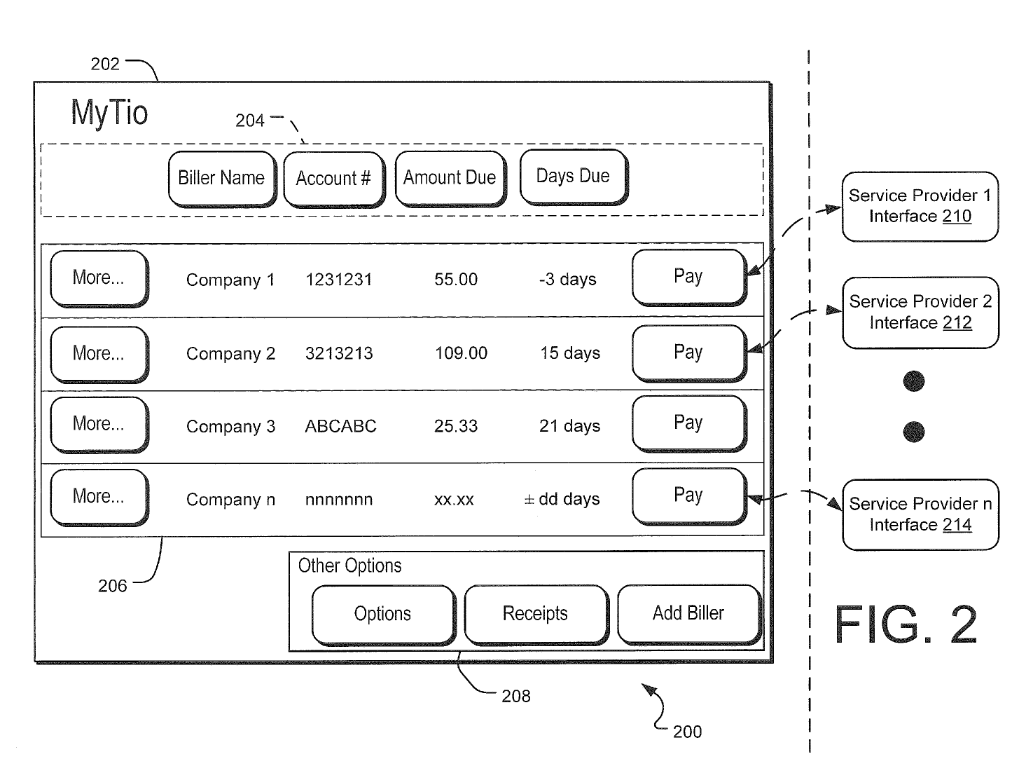

FIG. 2 illustrates a screenshot from a user interface of a self-service terminal 200. In one implementation, the screenshot 202 depicted in FIG. 2 provides a display of aggregated payment obligations to a plurality of payees. In another implementation, a user is first presented with a language-selection dialog (e.g., “Please select your language: English, Spanish, Other”). In yet another implementation, the kiosk displays scrolling advertising or other fluctuating content on the main welcome screen. The screenshot 202 presents a user with information associated with a plurality of payees 204, such as a payee identifier or biller name, an account identifier, an amount due, a due day, etc. In an implementation, the default sorting of the columns is to organize by due date of the payment obligation, with the payment obligation due first at the top of the column.

In some embodiments, information associated with a payment obligation that is due within a defined period of time is emphasized (e.g., flagged, highlighted or made prominent in some manner) to attract a user's attention. By way of example and not limitation, a payment obligation may be flagged through threshold criteria such as number of days until due, amount of payment due, etc. A payment obligation may also be flagged by a user, for example to a user may select to always highlight a cellular phone bill, a mortgage payment date, etc.

The user is presented with a number of action buttons that can be arranged, for example, into a sortable matrix 206. In operation, a user may select to pay a payment obligation among other options. As shown in FIG. 2, the displayed payment obligations may be linked to service provider interfaces 210-214. Furthermore, user may choose to select to obtain more information about a payee associated with the user account. In some embodiments, a display may present more information about the selected payee, such as but not limited to; dates of previous payments, locations of previous payments, amounts of previous payments, etc. In some embodiments, once a user has completed a payment to a selected billing account, the user can then apply any remaining funds to other billing accounts displayed on the screen.

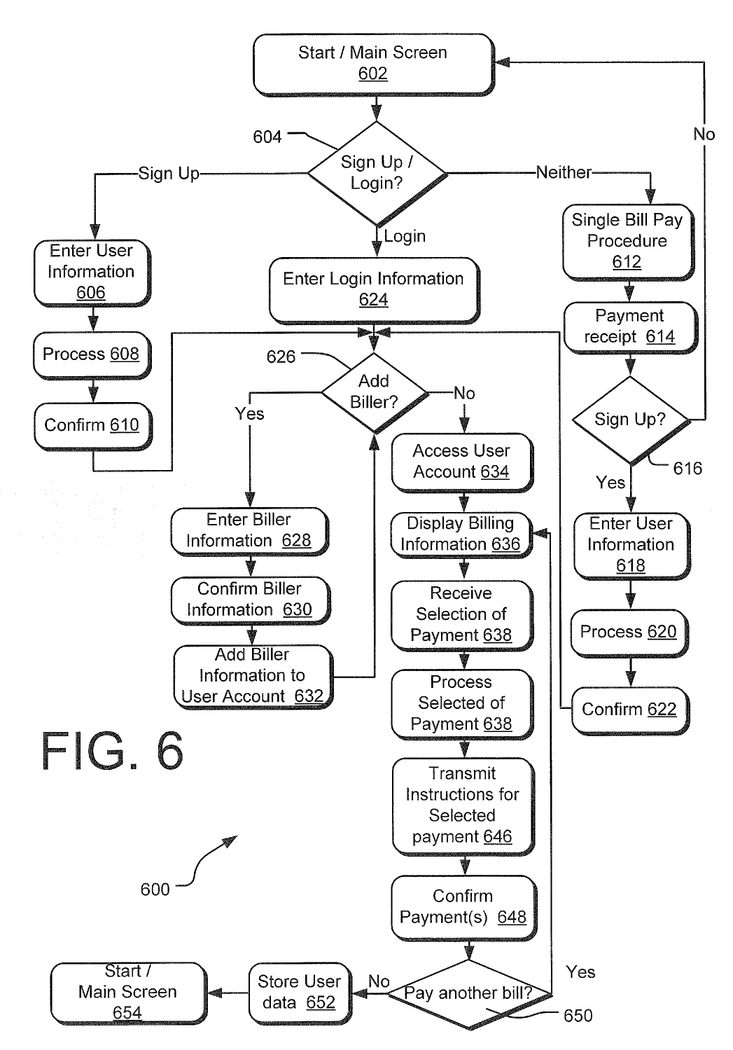

A user may also select “other options” 208 from the display 202 to access additional services. Examples of services that the user can access may include, but are not limited to, “options”, “receipts”, “history” and “add biller.” For example, a user may select the “options” button to gain access to user account information. The user can then edit user account settings, such as: username, password, bill payment reminders, etc. It should be noted that the above listing of offered services is for illustration only and does not include all possible additional services. Adding a biller is discussed in greater detail below with reference to FIG. 6.

Additional user-interaction screens are contemplated allowing the display and selection of other products and/or services or more finely tailored subsets of products and services. For example, paid advertisements for specific products and services could be displayed based on known-user marketing characteristics or user account preferences. Prior transaction history or other preferences for a particular user could be stored and used to select the products and services that the particular user has shown past interest in purchasing. In an alternate implementation, advertising could be displayed based on other parameters, such as kiosk location, date, season, etc.

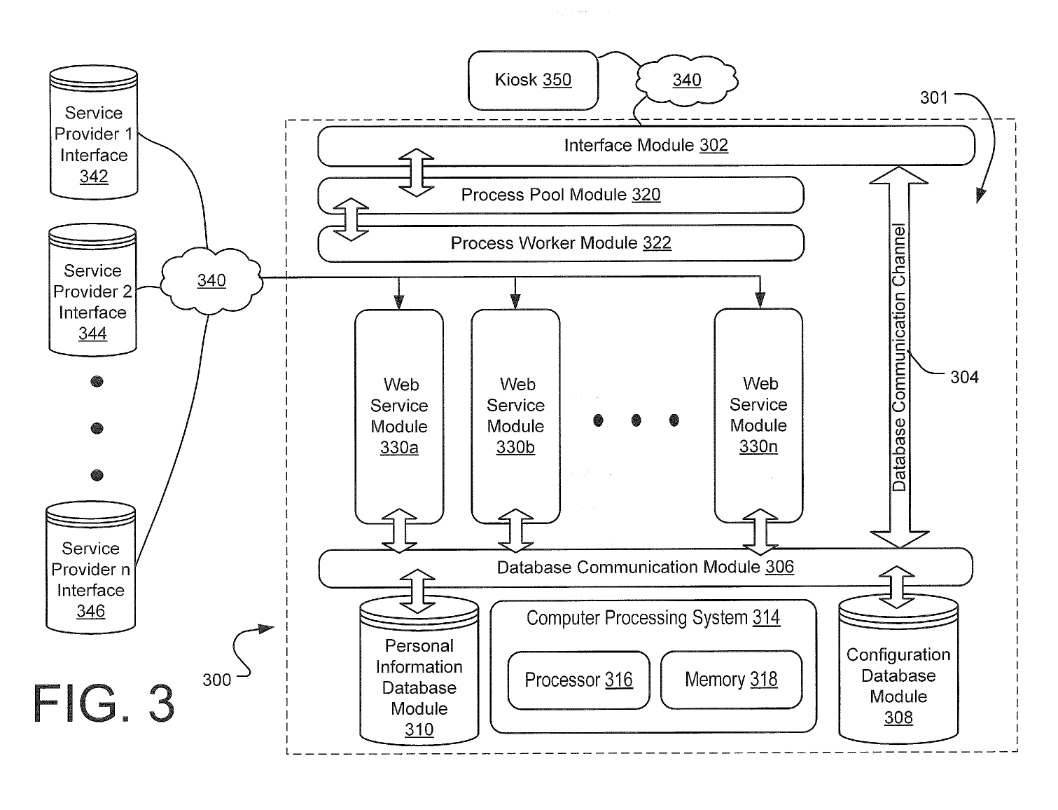

FIG. 3 schematically illustrates a personalized payment obligation database 300. The schematic displays a number of internal components 301, an exemplary self-service terminal 350 and exemplary service provider interfaces 342-346. In an implementation, service provider interfaces 342-346, and a self-service terminal 350 are communicatively associated with the payment obligation database 300 via a network 340.

The exemplary internal components include: interface module 302, database communication module 306, process pool module 320, process worker module 322 computer processing system 314, payee web service modules 330a-n, personal information database module 310 and configuration database module 308.

In an implementation, an interface module 302 is responsible for scheduling update processes. Furthermore, based on an interval time set in a configuration file the interface module 302 may invoke the process pool module 320. The configuration file may be stored in the configuration database module308. The interface module 302 may also be responsible for checking if an update process is already running, before initiating a new update process. In some embodiments, if an update process is already in running state, interface module 302 will not start a new update process. Furthermore, in some embodiments, interface module 302 may communicate updates to a self-service kiosk 350 via a network 340.

In an implementation, process pool module 320 may be responsible for fetching payee configuration information from configuration database module 308. In operation, process pool module 320 may start a separate web service module 330 for each payee whose information has been fetched from configuration database module 308. Furthermore, process pool module 320 may also ensure that the number of web service modules 330a-n processing never exceeds the maximum numbers of processes that are allowed to run at any instance of time. By way of example and not limitation, if there are more payees than a maximum number of threads allowed in a process, then a new web service module 330 process may started once the processing for any one payee is completed. In operation, running multiple web service modules 330a-n at the same time can ensure update processes are more performance effective. Furthermore, limiting the total number of web service module 330 processes, such as but not limited to one for each payee, may ensure that the server hosting the payment obligation database 300 is not overloaded.

In an implementation, process worker module 322 may create a payee web service modules 330a-n for each payee that has been initiated. The process worker module 322 may then load the payee web service modules 330a-n with payee data for further processing. In some embodiments, payee data may then be updated through an update process performed through interface module 302 with data retrieved from process pool module 320. Each payee web service module 330a-n may include all the data to be passed in a user request.

In an implementation, database communication module 306 allows for communication between interface module 302 and web service modules 330a-n, personal information database module 310 and configuration database module 308 through the database communication channel 304. Web service modules 330a-n are associated with service provider interfaces 342-346 on a one to one basis via a network 340. Web service modules 330a-n may include data such as but not limited to: a payee identifier, an account number identifier, account history, location information associated with previous transaction, payee profile information (e.g. name, address, account status), recent payment dates, recent payment amounts, etc.

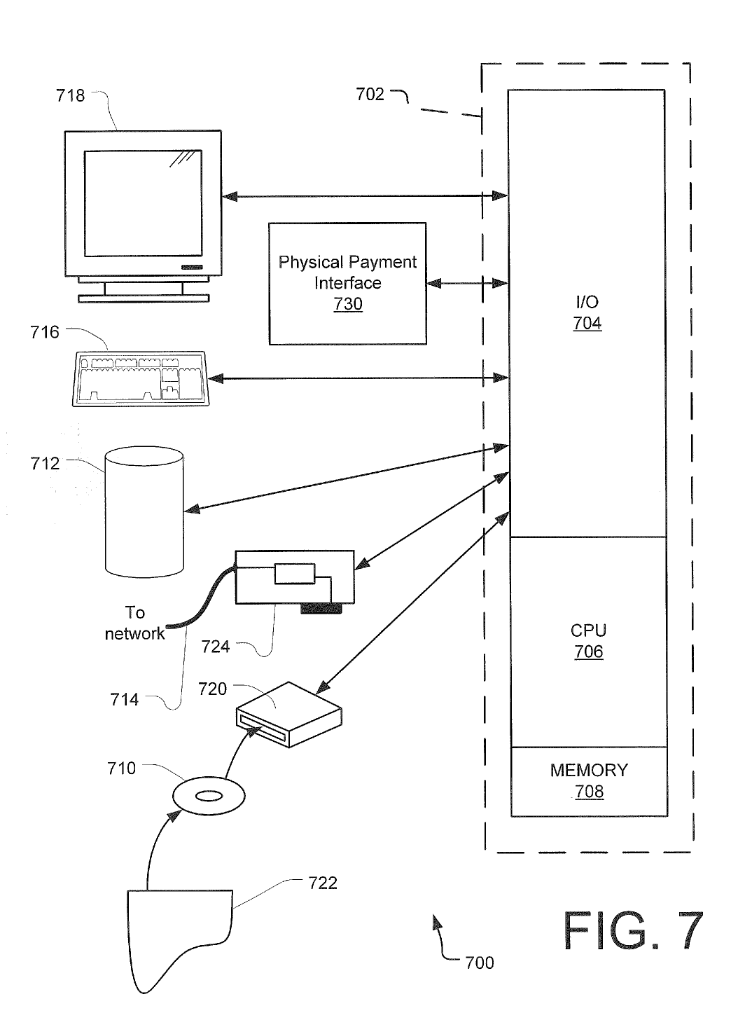

The computer processing system 314 can be a general purpose computing system. The computer processing system 314 is connected to all of the internal components 301. In one implementation, the computer processing system has a processor having an input/output (I/O) section, a central processing 316 section, and a memory section 318. There may be one or more processors 316, such that the processor 316 of the computer system comprises a single central processing unit, or a plurality of processing units, commonly referred to as a parallel processing environment. The computer system 314 may be a conventional computer, a distributed computer, or any other type of computer. The I/O section is connected to one or more adapters as well as a data storage unit such as a hard disk drive. Computer program products containing mechanisms to effectuate the systems and methods in accordance with the described technology may reside in the memory section, on a disk storage unit, on a DVD/CD-ROM medium connected to the computing system, or on a network storage location. Alternatively, a disk drive unit may be replaced or supplemented by a floppy drive unit, a tape drive unit, or other storage medium drive unit. See FIG. 7 for additional information concerning an exemplary computing system.

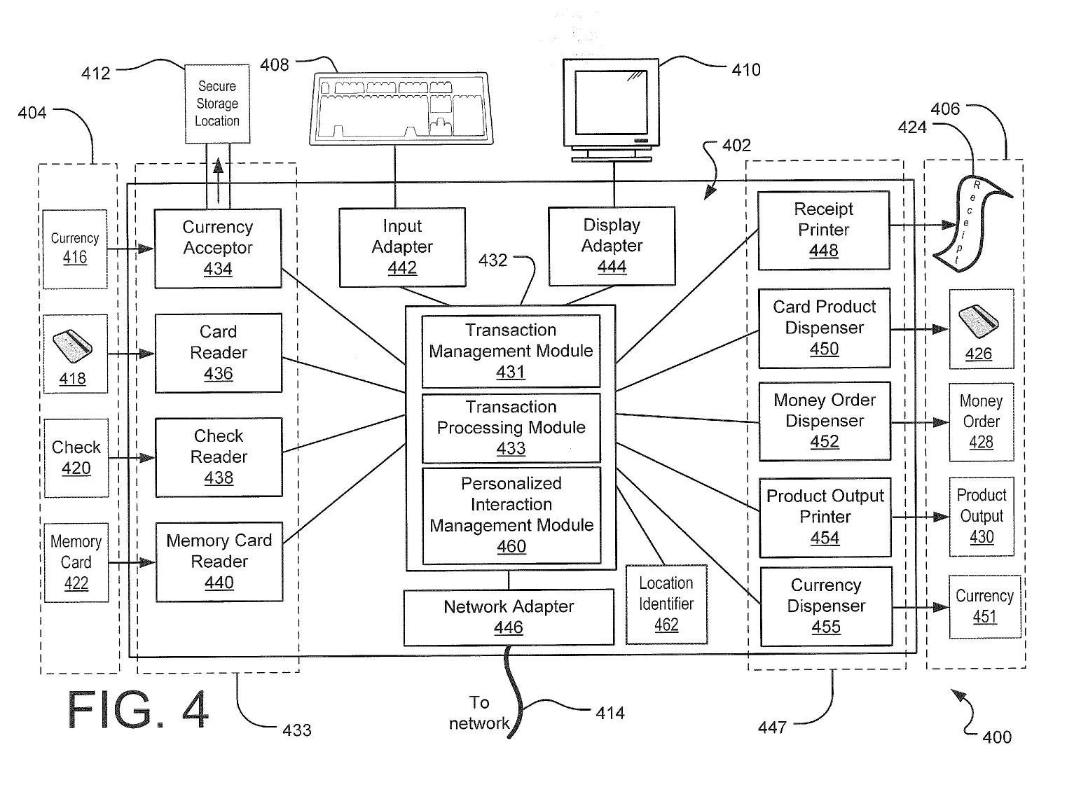

FIG. 4 schematically illustrates an exemplary self-service terminal 400. The schematic displays a number of internal components 402, exemplary inputs 404, exemplary outputs 406, an input device 408, a display device 410, and a secure storage location 412. Furthermore, the kiosk has a network connection 414. The exemplary inputs 404 include currency 416 (e.g., cash), cards 418 (e.g., credit cards, RFID cards, smart cards, etc.), checks 420, and memory card devices 422 (e.g., Memory Stick, SD card, Compact Flash, etc.). Other inputs are contemplated. The exemplary outputs 406 include receipts 424, magnetic stripe cards (e.g., gift cards, stored value cards, customer loyalty cards, etc.) 426, money orders 428, and product or service outputs 430 (e.g., printed movie tickets, lottery tickets, coupons, etc.). Other outputs are contemplated. The input device 408 can be a keyboard, a mouse, a trackball, a touch screen, PIN pad or any other input device or combination of input devices. The display device 410 can be a standard computer monitor, a flat-panel LCD display, a plasma display, etc. The secure storage location 412 can be a removable vault within the publically accessible self-service terminal in which the input currency 416 is stored while awaiting retrieval. In another implementation, the secure storage location 412 can be permanently affixed to the self-service terminal. In yet another implementation, the secure storage location 412 can be used to securely store checks, money orders, and other items in addition to cash. The network connection 414 connects self-service terminal to a network, thereby allowing the self-service terminal to connect to the products and services offered by the self-service terminal owner or other third-party product/service companies, such as but not limited to billers or payees

The self-service terminal 400 includes a location identifier 462. The location identifier 462 can include information pertaining to the physical location of the self-service terminal 400 such as: Global positioning System (GPS) data, latitude and longitude data, location name, store name, address, zip code, etc. Furthermore, the location identifier can provide information relating to the self-service terminal 400, such as: a service or transaction generated terminal identifier, a kiosk generated kiosk identifier, a Globally Unique Identifier (GUID), etc.

The internal components 402 are connected to a computer processing system 432. The components 402 can be categorized into three distinct groups. The first group of components 402 is input receivers 433, which can include a currency acceptor 434, a magnetic card reader 436, a check reader 438, memory card readers 440 and the like. Additional input devices are contemplated such as but not limited to a money order reader. The second group of components is adapters which can include an input adapter 442, a display adapter 444, and a network adapter 446. Other adapters are contemplated such as a sound card adapter. The third group of components is output devices 447, which can include a receipt printer 448, a card product dispenser 450, a money order dispenser 452, a product output printer 454, and a currency dispenser 455. Other output devices are contemplated such as a cashier's check printer or coin dispenser.

Generally, input receivers 433 receive input from a user. For example, a user can insert currency 416 into a self-service terminal via the currency acceptor 434. The currency acceptor may include a funds receiving physical payment interface 118, such as depicted in FIG. 1. In one implementation, the currency acceptor 434 can read paper bills, scan for counterfeit bills, reject questionable bills, return an unacceptable bill to a user, and basically perform any tasks associated with currency accepting devices. In another implementation, the currency acceptor 434 also accepts coins. In yet another implementation, the currency acceptor 434 can accept currency from two or more countries.

The card reader 436 accepts a card 418. In an implementation, the card 418 represents a magnetic strip card, such as a credit card (e.g., Mastercard, Visa, etc.), a debit card (e.g., an ATM or check card), and a stored value card. In another implementation, the card 418 represents a radio frequency identified (RFID) card or smart card (i.e. a card with embedded data storage). A stored value card (SVC) is similar to a debit card in that the SVC has an account associated with the card which can have funds added to and subtracted therefrom. An example of an SVC is a rechargeable merchant gift card—these cards are often purchased with an initial account balance and as each card is used to make purchases, the amounts of the purchases are deducted from the SVC's account. When the SVC account is depleted, a user can “recharge” the card by providing the merchant with additional funds which are then added to the SVC's account balance. A user can insert a magnetic card 418 and transfer funds from the card to the self-service terminal in order to be used for a transaction.

Another method for transferring funds to the self-service terminal is for the user to insert a check 420 into the check reader 438. The check reader 438 scans the check 420, locates appropriate bank routing and account numbers, and verifies that the check is drawn on a valid account containing sufficient funds. In one implementation, the check reader 438 scans the amount fields on the check 420. In another implementation, the user enters in the amount of the check 420. The check reader 438 can be configured to only accept certain types of checks (e.g., payroll checks, cashiers' checks, etc.). In yet another implementation, the self-service terminal communicates with other computers, such as the payment obligation database 110 depicted in FIG. 1, via the network 414 in order to verify the authenticity of a check and that sufficient funds are available in the associated checking account.

The memory card reader 440 accepts memory cards 422. Memory cards are relatively small electronic devices that store information. For example, many digital cameras and other hand-held consumer electronics utilize memory cards such as “memory sticks”, “compact flash cards”, “multimedia cards”, “secure digital cards”, “smartmedia flash cards”, “USB flash drives”, etc. Through the memory card reader 440, the user can upload digital photos and other personal files to the kiosk. Once the files have been uploaded a kiosk user can then utilize services on the kiosk (e.g., “work with photos”, “check email”, “surf the web”, etc.) that can interact with those files. For example, using the “work with photos” service, a user can upload digital photographs from a USB flash drive, edit the photos and then have the kiosk create prints. In one implementation, the memory card reader 440 provides connections to allow a user to plug in external devices. The connections can be of any type, including, USB, Fire-Wire, parallel, serial, infrared, PCMCIA, Bluetooth, 802.xx wireless, etc.

The adapters assist the self-service terminal in interacting with the external world. For example, the input adapter 442 accepts input commands from a user. The input adapter 442 can interact with the user via a keyboard 408 or any other user input device (e.g., a mouse, trackball, touchscreen, voice recognition device, etc.). Furthermore, the input adapter 442 can allow for multiple input devices to be used concurrently (e.g., the user can browse the menu commands using a mouse and type in an entry using a keyboard).

The display adapter 444 provides a medium for displaying a user interface on a display device 410. The display device 410 can be any type of display device, including, a standard cathode ray tube (CRT) computer monitor, an LCD screen, a plasma screen, etc. Furthermore, the display device 410 can also incorporate input features, such as those associated with a touchscreen. The display device 410 further incorporates other types of output directed to a user. For example, the display device 410 can have speakers over which the self-service terminal is able to communicate to the user via voice response, tones, and other sounds. In another example, the display device 410 can include two display devices where the first device can be used to allow a user access to the kiosk and the second display can be used for advertising purposes. In one implementation, the display adapter 444 handles all the input and output communications with the display device 410. In another implementation, other adapter devices are used concurrently to support additional input and output communications with the display device 410.

The network adapter 446 allows the self-service terminal to communicate with other computing devices via a network 414. In one implementation, the network adapter 446 is attached to the public Internet. In another implementation, the attached network 414 is a private Wide-Area-Network or WAN. In yet another implementation, the self-service terminal has a dedicated, secure connection to a network 414 that directly links the self-service terminal to one or more servers, such as the payment obligation server 110 depicted in FIG. 1.

Generally, the output devices 447 provide physical outputs to a user. For example, the receipt printer 448 prints a receipt for the user. In one implementation, a paper receipt is generated for each transaction. In another implementation, a receipt is generated only at the conclusion of all transactions by a single user. In yet another implementation, a user chooses to receive an email receipt instead of or in addition to the printed receipt.

The card product dispenser 450 outputs magnetic stripe cards 426 to a user. One example of an output card 426 is the stored value card (SVC) discussed above. The card product dispenser can encode information on the magnetic stripe of an SVC. In one implementation, the magnetic card reader 436 is physically distinct from the card product dispenser 450. In another implementation, a single device provides the functionalities of both the card reader 436 and the card product dispenser 450. Other types of information storage and transaction card devices are contemplated, including, “smartcards” that utilize a memory chip instead of a magnetic stripe, “wands” that utilize memory chips and wireless communication technologies such that no physical contact between the wand device and the reader is necessary, etc.

The money order dispenser 452 outputs money orders 428 to a user. The money order dispenser 452 can accept special print stock, allowing it to create money orders 428 with security-enhanced features. In one implementation, the money order dispenser 452 is dedicated to outputting only money orders 428. In an alternate implementation, the money order dispenser 452 is configured so that it can output other specialized print documents in addition to money orders 428.

The product output printer 454 prints product outputs 430. For example, the product output printer 454 can print movie theatre tickets or tickets to a baseball game. Additionally, the product output printer 454 can print any other type of output product including lottery tickets, coupons, donation certificates, gift awards, etc. In one implementation, the product output printer 454 does not print money orders. In another implementation, the product output printer can print money orders. In yet another implementation, the product output printer can print receipts, obviating the need for a distinct receipt printer 448.

The currency dispenser 455 outputs currency 451. For example, the currency dispenser can dispense coins, cash, stamps, etc. In one implementation, the currency dispenser 455 cannot dispense coins. In another implementation, the currency dispenser can dispense coins.

The computer processing system 432 can be a general purpose computing system. The computer processing system 432 is connected to all of the internal components 402. In one implementation, the computer processing system has a processor having an input/output (I/O) section, a central processing section, and a memory section. There may be one or more processors, such that the processor of the computer system comprises a single central processing unit, or a plurality of processing units, commonly referred to as a parallel processing environment. The computer system may be a conventional computer, a distributed computer, or any other type of computer. The I/O section is connected to one or more adapters (e.g., an input adapter 442, a display adapter 444, a network adaptor 446, etc.), as well as a data storage unit such as a hard disk drive. Computer program products containing mechanisms to effectuate the systems and methods in accordance with the described technology may reside in the memory section, on a disk storage unit, on a DVD/CD-ROM medium connected to the computing system, or on a network storage location. Alternatively, a disk drive unit may be replaced or supplemented by a floppy drive unit, a tape drive unit, or other storage medium drive unit. See FIG. 7 for additional information concerning an exemplary computing system.

In one implementation, the computer processing system 432 facilitates the operation of three modules: the transaction management module 431, the transaction processing module 433 and the personalized interaction management module 460. The management module 431 receives an originating instruction via the kiosk to originate payment associated with the selected payment obligation. The transaction processing module 433 executes any selected transactions. In one implementation, the first transaction processed by the processing module 433 results in a change amount in the electronic kiosk. The processing module 433 then communicates the change amount to the computer process that executes the second transaction using the change amount to fund the second transaction.

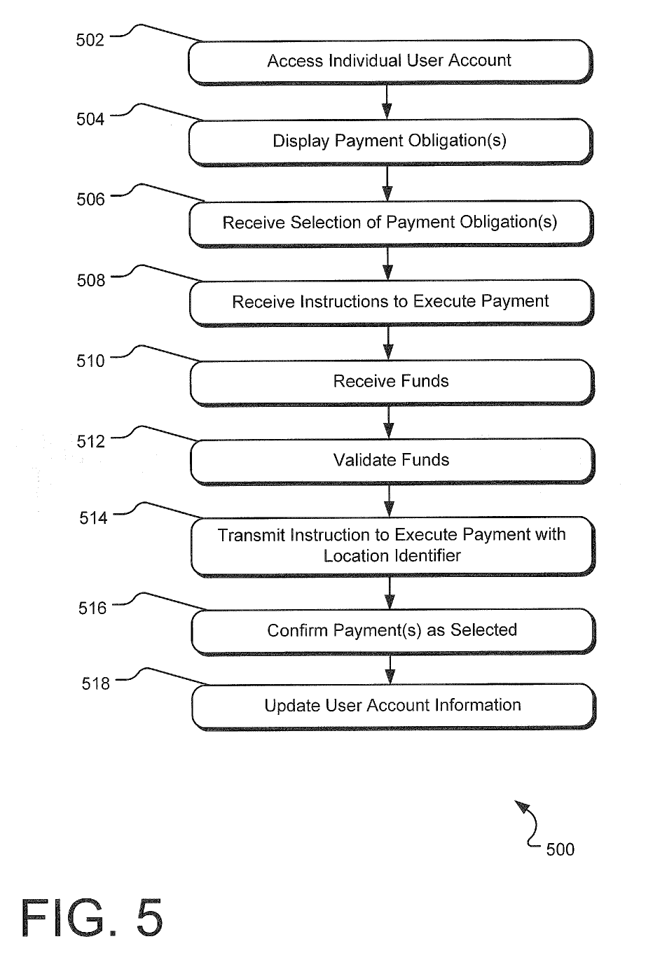

The personalized interaction management module 460 allows a user to access a user account, personalized with a user's preferences and including a data associated with a plurality of payment obligations. The personalized interaction management module 460 communicates user account selections to the computer process that communicates instructions to the network adapter 446 which communicates the instructions to a payment obligation database, such as the payment obligation database 110 depicted in FIG. 1, to implement the user selection. In operation, a user may select to initiate a personalized payment obligation service. The personalized interaction management module 460 receiving the user request and accesses a user account as defined by uniquely identify user information. A user then may select among a plurality of payment obligations through a plurality of interaction options. See FIGS. 5 and 6 for additional information concerning exemplary personalized payment obligation services.

FIG. 5 illustrates exemplary operations for processing a personalized transaction with a self-service terminal 500. Each described operation can be performed by one or more computer processes of the self-service terminal or connected transactions servers. The access individual user account operation 502 facilitates a user's selection to initiate retrieval of a user account and payment obligation data associated with the user account. In one implementation, access individual user account operation 502 presents the user with a sign in menu, where a user may input uniquely identifying user information to facilitate access to the user's account. In another implementation, access individual user account operation 502 presents a user with an option to sign up for a personalized payment obligation service. Signing up for the payment obligation service is described further with respect to FIG. 6.

The display payment obligations operation 504 presents user account data. In an implementation, the display payment obligations operation 504 tailors the menu of possible product and service selections based on parameters such as user profile information, location of kiosk, time/date/season of transaction, available advertisers, user marketing information, amount of funds deposited, etc. In another implementation, a user's account information is presented in a sortable matrix of data comprising a plurality of payees and a plurality of data associated with the payees. A user may interact with the self-service terminal and selects a particular product or service as the desired transaction.

The receive selection of payment obligation operation 506 analyzes the product or service selected by the user. The receive selection of payment obligation operation 506 can incorporate user profile and/or kiosk location information to calculate additional charges such as taxes and fees, compute the total funds required, and display the results to the user. In one implementation, the receive selection of payment obligation operation 506 displays the final total as well as additional detail information concerning funds required to complete a user-specified transaction.

The receive instructions to execute payment operation 508 analyzes the product or service selected by the user to determine an amount to charge the user for the transaction. The receive instructions to execute payment operation 508 accepts a user input prompting the self-service terminal that a selection has been made to pay at least one payment obligation.

The receive funds operation 510 prompts the user to insert funds into the self-service terminal. Depending on installed options and parameters for a given user profile and system information, the receive funds operation 510 displays the funding options available to the user, including, but not limited to, inserting cash; charging a credit card, debit card, check card, or SVC; inserting a check; inserting a money order; transferring funds electronically; initiating a bank wire transaction; etc. The receive funds operation 510 communicates with the input receivers to verify receipt of funds and prompts the user to insert additional funds if the amount already inserted is less than the final total of funds required.

The validate funds operation 512 analyzes received funds to confirm the acceptability and/or amount of the funds. In an implementation, this validation may be performed at the self-service terminal. In another implementation, data may be transmitted to a server to validate the funds.

The transmit instruction to execute payment with location identifier operation 514 facilitates transmission of data from the self-service terminal to a payment obligation database, such as the payment obligation database 110 depicted in FIG. 1. In an implementation, a location identifier uniquely identifying the self-service terminal from which the transmission is sent is associated with the transmission. The location identifier may include information pertaining to the physical location of the self-service terminal 400 such as: Global positioning System (GPS) data, latitude and longitude data, location name, store name, address, zip code, etc. Furthermore, the location identifier can provide information relating to the self-service terminal 400, such as: a service or transaction generated terminal identifier, a kiosk generated kiosk identifier, a Globally Unique Identifier (GUID), etc.

The confirm payments as selected operation 516 presents confirmation to a user that inputted funds have been applied to the selected payment obligations. In an implementation, confirmation may include: a displayed image, a printed receipt, etc.

The update user account information operation 518 prompts the self-service terminal to provide at least some data to a payment obligation database to update a user account to include the just completed and confirmed transaction. In an implementation, data sent in update the user account may include: location of payment, payee identifier, amount of payment and the like.

In another implementation, the system utilizes the user's updated account information to present only those transactions that the user has commonly chosen in the past. In yet another implementation, the system presents transactions that are chosen based on a determined geographic location for the self-service terminal when compared to nearby stores or other entities sponsoring the possible transactions. For example, suppose the location for a self-service terminal is determined and there is a convenience store nearby that has agreed to sponsor a coupon. The self-service terminal can include a coupon for the particular convenience store.

FIG. 6 illustrates an additional set of exemplary operations for creating a personalized user account and a personalized transaction with a self-service terminal 600. Each described operation can be performed by one or more computer processes of the electronic kiosk or connected transactions servers. The Start/Main Screen operation 602 presents a user with a main screen providing a plurality of interactive options. In an implementation, one of these includes an option to access a personalized user account.

At operation 604 a user is prompted to select whether to access a personalized user account. If at operation 604, the user chooses not to select the personalized user account, then at operation 612 a single payment process in initiated. After a user completes the selected single payment process at operation 614, the user is then prompted again to determine if the user would like to sign up for the personalized payment obligation system at operation 616. If the user again chooses not to sign up than the system returns to a main menu 602.

By contrast, if at operation 604 or operation 616 a user selects to initialize the personalized user account, then a user is either prompted to sign up for or sign into a personalized user account. If at operation 604 a user does not have an existing account, the user is prompted to provide uniquely identifying user information at operation 606, such as but not limited to, a user phone number, a user password, and a username. At operation 608 the user information is received processed to create the personalized user account. At operation 610 the user is informed of the successful completion of the sign up process.

If at operation 604 or operation 616, a user has already created a user account, then the user is prompted to input login information at operation 624 similar to the uniquely identifying user information described with respect to operation 606.

Among other options, a user may select to add billers (i.e. payees) to the user account at operation 626. If at operation 626, a user selects to add a payee, then the user is prompted to provide biller information to access the billing account and to link the biller with the user. In an implementation, the user may provide a billing account number, a phone number linking the user with the account, and the like. In another implementation, the user selects a biller from a set displayed on the self-service terminal.

Once a user has provided sufficient data to link the biller to the user account, the biller information is confirmed at operation 630 and the billing account is added to the user account at operation 632.

If a user does not select to add payees to the user account, then the user account is accessed at operation 634 through the user login information. The display billing information operation 636 presents user account data to the user. In an implementation, the display billing information operation 636 tailors the menu of possible products and services based on parameters such as user profile information, location of kiosk, time/date/season of transaction, available advertisers, user marketing information, amount of funds deposited, etc. In another implementation, a user's account information is presented in a sortable matrix of data including a plurality of billers. A user may interact with the self-service terminal and select a particular product or service as the desired transaction.

The receive selection of payment operation 638 analyzes the product or service selected by the user. The receive selection of payment operation 638 can incorporate user profile and/or kiosk location information to calculate additional charges such as taxes and fees, compute the total funds required, and display the results to the user. In one implementation, the receive selection of payment operation 638 displays the final total as well as additional detail information concerning funds required to complete a user-specified transaction.

The process selected payment operation 640 analyzes the product or service selected by the user to determine an amount to charge the user for the transaction. Process selected payment operation 640 accepts a user input prompting the self-service terminal that a selection has been made to pay at least one payment obligation. In an implementation, the self-service terminal then receives funds as part of processing the selected payment. The user can insert funds into the self-service terminal. Depending on installed options and parameters for a given user profile and system information, the receive funds operation 642 displays the funding options available to the user, including, but not limited to, inserting cash; charging a credit card, debit card, check card, or SVC; inserting a check; inserting a money order; transferring funds electronically; initiating a bank wire transaction; etc. The receive funds operation 642 communicates with the input receivers to verify receipt of funds and prompts the user to insert additional funds if the amount already inserted is less than the final total of funds required.

The validate funds operation 644 analyzes received funds to confirm the acceptability of the funds. In an implementation, this validation may be performed at the self-service terminal. In another implementation, data may be transmitted to a server to validate the funds.

The transmit instruction to execute payment operation 646 facilitates transmission of data from the self-service terminal to a payment obligation database. In an implementation, a location identifier uniquely identifying the self-service terminal from which the transmission is sent is associated with the transmission. The location identifier can include information pertaining to the physical location of the self-service terminal such as: Global positioning System (GPS) data, latitude and longitude data, location name, store name, address, zip code, etc. Furthermore, the location identifier can provide information relating to the self-service terminal, such as: a service or transaction generated terminal identifier, a kiosk generated kiosk identifier, a Globally Unique Identifier (GUID), etc.

The confirm payments as selected operation 648 presents confirmation to a user that inputted funds have been applied to the selected payment obligations. In an implementation, confirmation may include: a displayed image, a printed receipt, etc.

At operation 650, the option to pay another payment obligation is presented. If a user selects to pay another payment obligation the system displays the payee data associated with the user account at operation 636. In an implementation, the displayed payee data has been updated in incorporate data from the completed transaction.

By contrast, if at operation 650, a user selects to not pay additional payment obligations, at least some data associated with the transaction is stored with the user account at operation 652 and the system returns to a main screen at operation 654. In an implementation, some of the data stored includes: user name, user address, product or service specific account information, social security number, etc.

FIG. 7 illustrates an exemplary system that may be useful in implementing the described technology. A general purpose computer system 700 is capable of executing a computer program product to execute a computer process. Data and program files may be input to the computer system 700, which reads the files and executes the programs therein. Some of the elements of a general purpose computer system 700 are shown in FIG. 7 wherein a processor 702 is shown having an input/output (I/O) section 704, a Central Processing Unit (CPU) 706, and a memory section 708. There may be one or more processors 702, such that the processor 702 of the computer system 700 comprises a single central-processing unit 706, or a plurality of processing units, commonly referred to as a parallel processing environment. The computer system 700 may be a conventional computer, a distributed computer, or any other type of computer. The described technology is optionally implemented in software devices loaded in memory 708, stored on a configured DVD/CD-ROM 710 or storage unit 712, and/or communicated via a wired or wireless network link 714 on a carrier signal, thereby transforming the computer system 700 in FIG. 7 into a special purpose machine for implementing the described operations.

The I/O section 704 is connected to one or more user-interface devices (e.g., a keyboard 716, a display unit 718, and a physical payment interface 730), a disk storage unit 712, and a disk drive unit 720. Generally, in contemporary systems, the disk drive unit 720 is a DVD/CD-ROM drive unit capable of reading the DVD/CD-ROM medium 710, which typically contains programs and data 722. Implementing the general purpose computer system 700 as part of an electronic kiosk can involve extensive use of the I/O section 704. The kiosk's physical payment interface 730 (e.g., a currency acceptor, magnetic card reader, check reader, and memory card reader) can be connected to the I/O section 704. The kiosk's output devices (e.g., a receipt printer, card product dispenser, money order dispenser, and product output printer) can also be connected to the I/O section 704.

In one implementation, the kiosk (whether by its own determination or by instruction from a back-end service) may limit functionality and/or disable payment or partial payment through the physical payment interface 730. For example, under certain regulations, the aggregate transaction amount that can be transacted using cash by an individual user or to an individual payee in a 24 hour period is limited to $2000. Furthermore, as the user account can manage multiple payment obligations and multiple payees, the kiosk or back-end service can monitor the currency transaction across multiple payees by an individual user. As such, if the kiosk or the back-end payment service detects that an individual user will exceed such a threshold by inputing additional currency into a currency acceptor, the kiosk may reject such input to maintain compliance with such regulations.

Computer program products containing mechanisms to effectuate the systems and methods in accordance with the described technology may reside in the memory section 708, on a disk storage unit 712, or on the DVD/CD-ROM medium 710 of such a system 700. Alternatively, a disk drive unit 720 may be replaced or supplemented by a floppy drive unit, a tape drive unit, or other storage medium drive unit. The network adapter 724 is capable of connecting the computer system to a network via the network link 714, through which the computer system can receive instructions and data embodied in a carrier wave.

When used in a LAN-networking environment, the computer system 700 is connected (by wired connection or wirelessly) to a local network through the network interface or adapter 724, which is one type of communications device. When used in a WAN-networking environment, the computer system 700 typically includes a modem, a network adapter, or any other type of communications device for establishing communications over the wide area network. In a networked environment, program modules depicted relative to the computer system 700 or portions thereof, may be stored in a remote memory storage device. It is appreciated that the network connections shown are exemplary and other means of and communications devices for establishing a communications link between the computers may be used.

In accordance with an implementation, software instructions and data directed toward implementing change-based transactions for an electronic kiosk and associated operations may reside on the disk storage unit 712, disk drive unit 720 or other storage medium units coupled to the system. Said software instructions may also be executed by CPU 706.

The technology described herein is implemented as logical operations and/or modules in one or more systems. The logical operations may be implemented (1) as a sequence of processor-implemented steps executing in one or more computer systems and (2) as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. In particular, it should be understand that the described technology may be employed independent of a personal computer. Other embodiments are therefore contemplated.

What is claimed is:

1. A method of originating a financial transaction through a self-service terminal including a physical payment interface, the method comprising:
accessing a user account via the self-service terminal, the user account identifying payment obligations of a user to a plurality of payees;
detecting selection of an identified payment obligation to a payee via the self service terminal;
receiving an originating instruction via the self-service terminal to originate payment associated with the selected payment obligation, funds designated for the payment being specified via the physical payment interface of the self-service terminal; and
transmitting a payment instruction specifying the payment for application against the selected payment obligation.

2. The method of claim 1 wherein accessing a user account comprises:
receiving uniquely identifying user information via the self-service terminal;
transmitting the uniquely identifying user information to a payment obligation database; and
receiving access to the user account associated with the uniquely identifying user information.

3. The method of claim 1, wherein detecting selection of an identified payment obligation to a payee comprises:
displaying the identified payment obligation on the self-service terminal; and
receiving an input from the user selecting the identified payment obligation.

4. The method of claim 1, further comprising:
displaying the identified payment obligation in association with at least one of: a payee identifier, an account identifier, an amount due, a location identifier and a due date for a payment obligation of the user to a payee.

5. The method of claim 1, further comprising:
displaying the identified payment obligation in a sortable matrix of the payment obligations, the sortable matrix being sortable by at least one of the criteria of: a payee identifier, an account identifier, an amount due, a location identifier and a due date for a payment obligation.

6. The method of claim 1, further comprising:
displaying with emphasis the identified payment obligation that is due within a predetermined increment of time.

7. The method of claim 1, further comprising:
validating funds designated for the payment via the physical payment interface.

8. The method of claim 1, further comprising:
validating at least one of: the funds amount, a source of the funds, a location identifier associated with the self-service terminal, and whether the funds can be applied to the selected payment obligation.

9. The method of claim 1, further comprising:
creating the user account via the self-service terminal.

10. The method of claim 1, further comprising:
initializing the user account through the self-service terminal, the user account allowing access to the identified payment obligations;
recieving a user instruction to modify an identified payment obligation of the user; and
transmitting a modification instruction specifying the identified payment obligation and modification to be applied.

11. The method of claim 1, further comprising:
receiving user information uniquely identifying the user to set up a user account.

12. The method of claim 1, further comprising:
receiving a user instruction to add, subtract or modify a feature associated with an identified payment obligation.

13. The method of claim 12, wherein the feature includes at least one of: a payee identifier, an account identifier, a location identifier, an amount due and a due date for a payment obligation.

14. The method of claim 1, further comprising:
rejecting input of additional cash into the physical payment interface if the additional cash would cause the user to exceed a specified threshold for cash transactions in a specified period.

15. A computer-readable storage medium encoding a computer program for executing on a computer system a computer process that originates a financial transaction through a self-service terminal including a physical payment interface, the computer process comprising:
accessing a user account via the self-service terminal, the user account identifying payment obligations of a user to a plurality of payees;
detecting selection of an identified payment obligation to a payee via the self service terminal;
receiving an originating instruction via the self-service terminal to originate payment associated with the selected payment obligation, funds designated for the payment being specified via the physical payment interface of the self-service terminal; and
transmitting a payment instruction specifying the payment for application against the selected payment obligation.

16. The computer-readable storage medium of claim 15 wherein accessing a user account comprises:
receiving uniquely identifying user information via the self-service terminal;
transmitting the uniquely identifying user information to a payment obligation database; and
receiving access to the user account associated with the uniquely identifying user information.

17. The computer-readable storage medium of claim 15, wherein detecting selection of an identified payment obligation to a payee comprises:
displaying the identified payment obligation on the self-service terminal; and
receiving an input from the user selecting the identified payment obligation.

18. The computer-readable storage medium of claim 15, wherein the computer process further comprises:
displaying with emphasis the identified payment obligation that satisfies a specified condition.

19. The computer-readable storage medium of claim 15, wherein the computer process further comprises:
validating funds designated for the payment via the physical payment interface.

20. The computer-readable storage medium of claim 15, wherein the computer process further comprises:
validating at least one of: the funds amount, a source of the funds, a location identifier associated with the self-service terminal, and whether the funds can be applied to the selected payment obligation.

21. The computer-readable storage medium of claim 15, further comprising:
rejecting input of additional cash into the physical payment interface if the additional cash would cause the user to exceed a specified threshold for cash transactions in a specified period.

22. A self-service terminal that originates a financial transaction, the self-service terminal comprising:
a physical payment interface integrated with the self-service terminal;
a personalized interaction management module that accesses a user account, the user account identifying payment obligations of a user to a plurality of payees;
an input adapter that detects selection of an identified payment obligation to a payee;
a transaction management module that receives an originating instruction via the self-service terminal to originate payment associated with the selected payment obligation, funds designated for the payment being specified via the physical payment interface; and
a transaction processing module that transmits a payment instruction specifying the payment for application against the selected payment obligation.

23. A method of processing a financial transaction originated from a self-service terminal, the method comprising:
receiving a request from the self-service terminal to access a user account, the user account identifying payment obligations of a user to a plurality of payees;
transmitting data associated with the user account to the self-service terminal;
receiving a payment instruction from the self-service terminal to execute a payment associated with a payment obligation to a payee identified by the user account, the payment instruction identifying a location identifier associated with the self-service terminal; and
transmitting a service instruction to execute the payment.

24. The method of claim 23, further comprising:
retrieving a payment obligation of the user from a payee identified in the user account.

25. The method of claim 23, further comprising:
retrieving a payment obligation of the user from a payee identified in the user account on demand, responsive to receiving the request from the self-service terminal.

26. The method of claim 23, further comprising:
granting the user with access to the user account based on uniquely identifying user information.

27. A computer-readable storage medium encoding a computer program for executing on a computer system a computer process that processes a financial transaction originated from a self-service terminal, the computer process comprising:
receiving a request from the self-service terminal to access a user account, the user account identifying payment obligations of a user to a plurality of payees;
transmitting data associated with the user account to the self-service terminal;
receiving a payment instruction from the self-service terminal to execute a payment associated with a payment obligation to a payee identified by the user account, the payment instruction identifying a location identifier associated with the self-service terminal; and
transmitting a service instruction to execute the payment.

28. The computer-readable storage medium of claim 27, wherein the computer process further comprises:
retrieving a payment obligation of the user from a payee identified in the user account.

29. The computer-readable storage medium of claim 27, wherein the computer process further comprises:
retrieving a payment obligation of the user from a payee identified in the user account on demand, responsive to receiving the request from the self-service terminal.

30. The computer-readable storage medium of claim 27, wherein the computer process further comprises:
granting the user with access to the user account based on uniquely identifying user information.
